(19) United States
(12) Patent Application Publication
(10) Pub. No.: US 2015/0331608 A1
(43) Pub. Date: Nov. 19, 2015

(54) ELECTRONIC SYSTEM WITH TRANSACTIONS AND METHOD OF OPERATION THEREOF

(71) Applicant: Samsung Electronics Co., Ltd., Suwon-si (KR)

(72) Inventors: Edwin Silvera, Austin, TX (US); Murali Chinnakonda, Austin, TX (US); Tarun Nakra, Austin, TX (US); Kevin Lepak, Austin, TX (US)

(21) Appl. No.: 14/542,308

(22) Filed: Nov. 14, 2014

Related U.S. Application Data
(60) Provisional application No. 61/994,278, filed on May 16, 2014.

(51) Int. Cl. G06F 3/06; G06F 12/08

(52) U.S. Cl. CPC G06F 3/061; G06F 12/0811; G06F 3/065; G06F 3/068; G06F 2212/283

(57) ABSTRACT

An electronic system includes: a storage unit configured to store a data array; a control unit configured to: determine availability of the data array; reorder access to the data array; and provide access to the data array.

### CROSS-REFERENCE TO RELATED APPLICATION(S)

This application claims the benefit of U.S. Provisional Patent Application Ser. No. 61/994,278 filed May 16, 2014, and the subject matter thereof is incorporated herein by reference thereto.

### TECHNICAL FIELD

An embodiment of the present invention relates generally to an electronic system, and more particularly to a system for transactions.

### BACKGROUND

Modern consumer and industrial electronics, especially electronic devices such as graphical display systems, televisions, projectors, cellular phones, portable digital assistants, and combination devices, are providing increasing levels of performance and functionality to support modern life. Research and development in the existing technologies can take a myriad of different directions.

One such direction includes improvements in memory or storage. Faster memory or storage capacity is typically more costly, higher in power consumption, or larger in size, than slower memory or storage. As electronic devices become smaller, lighter, and require less power, the amount of faster memory can be limited. Efficiently or effectively using the faster memory or storage can provide the increased levels of performance and functionality.

These performance and functionality improvements can include faster processing of information including access to saved information. The saved information can include information arranged or arrayed in memory or storage. The faster processing can include overlapping such as concurrent processing or accessing of the saved information. The saved information can include temporarily saved information particularly with a smaller and faster memory or storage such as a cache.

Thus, a need still remains for an electronic system with faster processing of information particularly in temporary storage such as a cache. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system including: a storage unit configured to store a data array; a control unit configured to: determine availability of the data array; reorder access to the data array; and provide access to the data array.

An embodiment of the present invention provides a method of operation of an electronic system including: storing, with a storage unit, a data array; determining, with a control unit, availability of the data array; reordering access to the data array; and providing access to the data array.

An embodiment of this invention addresses L2 resource contention arising from concurrent transactions trying to access the internal L2 resources. Embodiments avoid these contention cases by either reordering or rescheduling the transactions, thereby maximizing the delivered L2 bandwidth within the underlying design constraints.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an exemplary block diagram of the electronic system in an embodiment of the invention.

FIG. 2 is a flow chart of a scheduler process of the electronic system in an embodiment of the invention.

FIG. 3 is a diagram of an example of a pipeline process of the electronic system in an embodiment of the invention.

FIG. 4 is a diagram of an example of a pipeline process of the electronic system in an embodiment of the invention.

FIG. 5 is a diagram of an example of a cache configuration of the electronic system in an embodiment of the invention.

FIG. 6 includes exemplary embodiments of the electronic system.

FIG. 7 is a flow chart of a method of operation of an electronic system in an embodiment of the present invention.

### DETAILED DESCRIPTION

An embodiment of this invention addresses Level 2 cache (L2 cache) resource contention arising from concurrent transactions trying to access internal L2 resources, particularly if transactions are close to each other. Some transactions can be well spaced-out and scheduled at an early cycle without re-ordering. Otherwise, those contention cases can be avoided by either reordering or rescheduling the transactions, and thereby maximizes the delivered L2 bandwidth within the underlying design constraints.

The following embodiments are described in sufficient detail to enable those skilled in the art to make and use the invention. It is to be understood that other embodiments would be evident based on the present disclosure, and that system, process, or mechanical changes may be made to embodiments without departing from the scope of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “process” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

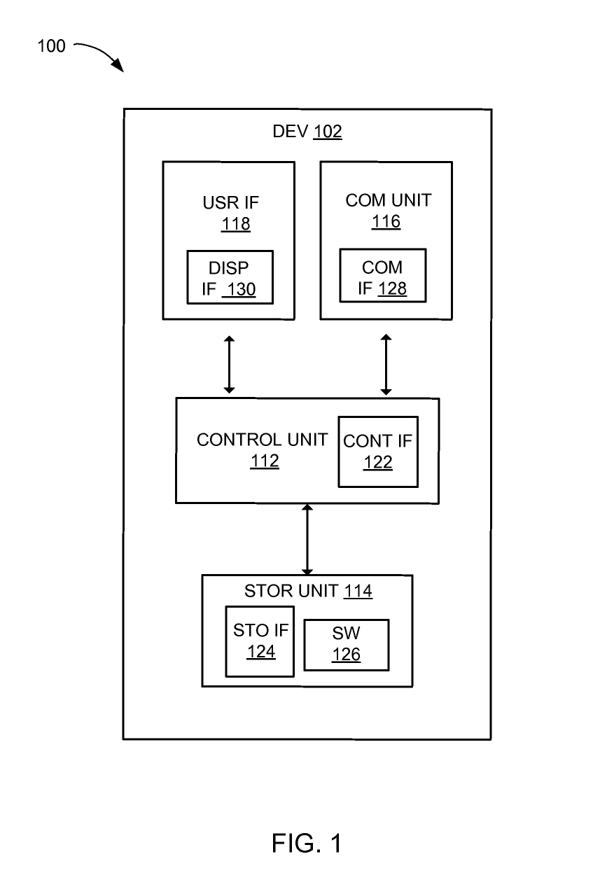

Referring now to FIG. 1, therein is shown an exemplary block diagram of the electronic system 100 in an embodiment of the invention. The electronic system 100 can include a device 102. The device 102 can include a client device, a server, a display interface, or combination thereof.

The device 102 can include a control unit 112, a storage unit 114, a communication unit 116, and a user interface 118. The control unit 112 can include a control interface 122. The control unit 112 can execute software 126 of the electronic system 100.

The control unit 112 can be implemented in a number of different manners. For example, the control unit 112 can be a processor, an application specific integrated circuit (ASIC) an embedded processor, a microprocessor, a hardware control logic, a hardware finite state machine (FSM), a digital signal processor (DSP), or a combination thereof. The control interface 122 can be used for communication between the control unit 112 and other functional units in the device 102. The control interface 122 can also be used for communication that is external to the device 102.

The control interface 122 can receive information from the other functional units or from external sources, or can transmit information to the other functional units or to external destinations. The external sources and the external destinations refer to sources and destinations external to the device 102.

The control interface 122 can be implemented in different ways and can include different implementations depending on which functional units or external units are being interfaced with the control interface 122. For example, the control interface 122 can be implemented with a pressure sensor, an inertial sensor, a microelectromechanical system (MEMS), optical circuitry, waveguides, wireless circuitry, wireline circuitry, or a combination thereof.

The storage unit 114 can store the software 126. The storage unit 114 can also store relevant information, such as data, images, programs, sound files, or a combination thereof. The storage unit 114 can be sized to provide additional storage capacity.

The storage unit 114 can be a volatile memory, a nonvolatile memory, an internal memory, an external memory, or a combination thereof. For example, the storage unit 114 can be a nonvolatile storage such as non-volatile random access memory (NVRAM), Flash memory, disk storage, or a volatile storage such as static random access memory (SRAM), dynamic random access memory (DRAM), any memory technology, or combination thereof

The storage unit 114 can include a storage interface 124. The storage interface 124 can be used for communication with other functional units in the device 102. The storage interface 124 can also be used for communication that is external to the device 102.

The storage interface 124 can receive information from the other functional units or from external sources, or can transmit information to the other functional units or to external destinations. The external sources and the external destinations refer to sources and destinations external to the device 102.

The storage interface 124 can include different implementations depending on which functional units or external units are being interfaced with the storage unit 114. The storage interface 124 can be implemented with technologies and techniques similar to the implementation of the control interface 122.

For illustrative purposes, the storage unit 114 is shown as a single element, although it is understood that the storage unit 114 can be a distribution of storage elements. Also for illustrative purposes, the electronic system 100 is shown with the storage unit 114 as a single hierarchy storage system, although it is understood that the electronic system 100 can have the storage unit 114 in a different configuration. For example, the storage unit 114 can be formed with different storage technologies forming a memory hierarchal system including different levels of caching, main memory, rotating media, or off-line storage.

The communication unit 116 can enable external communication to and from the device 102. For example, the communication unit 116 can permit the device 102 to communicate with a second device (not shown), an attachment, such as a peripheral device, a communication path (not shown), or combination thereof.

The communication unit 116 can also function as a communication hub allowing the device 102 to function as part of the communication path and not limited to be an end point or terminal unit to the communication path. The communication unit 116 can include active and passive components, such as microelectronics or an antenna, for interaction with the communication path.

The communication unit 116 can include a communication interface 128. The communication interface 128 can be used for communication between the communication unit 116 and other functional units in the device 102. The communication interface 128 can receive information from the other functional units or can transmit information to the other functional units.

The communication interface 128 can include different implementations depending on which functional units are being interfaced with the communication unit 116. The communication interface 128 can be implemented with technologies and techniques similar to the implementation of the control interface 122, the storage interface 124, or combination thereof.

The user interface 118 allows a user (not shown) to interface and interact with the device 102. The user interface 118 can include an input device, an output device, or combination thereof. Examples of the input device of the user interface 118 can include a keypad, a touchpad, soft-keys, a keyboard, a microphone, an infrared sensor for receiving remote signals, other input devices, or any combination thereof to provide data and communication inputs.

The user interface 118 can include a display interface 130. The display interface 130 can include a display, a projector, a video screen, a speaker, or any combination thereof.

The control unit 112 can operate the user interface 118 to display information generated by the electronic system 100. The control unit 112 can also execute the software 126 for the other functions of the electronic system 100. The control unit 112 can further execute the software 126 for interaction with the communication path via the communication unit 116.

The device 102 can also be optimized for implementing an embodiment of the electronic system 100 in a multiple device embodiment. The device 102 can provide additional or higher performance processing power.

The electronic system 100 can be implemented by the control unit 112. For illustrative purposes, the device 102 is shown partitioned with the user interface 118, the storage unit 114, the control unit 112, and the communication unit 116, although it is understood that the device 102 can have any different partitioning. For example, the software 126 can be partitioned differently such that at least some function can be in the control unit 112 and the communication unit 116. Also, the device 102 can include other functional units not shown in for clarity.

The functional units in the device 102 can work individually and independently of the other functional units. For illustrative purposes, the electronic system 100 is described by operation of the device 102 although it is understood that the device 102 can operate any of the processes and functions of the electronic system 100.

Processes in this application can be hardware implementations, hardware circuitry, or hardware accelerators in the control unit 112. The processes can also be implemented within the device 102 but outside the control unit 112.

Processes in this application can be part of the software 126. These processes can also be stored in the storage unit 114. The control unit 112 can execute these processes for operating the electronic system 100.

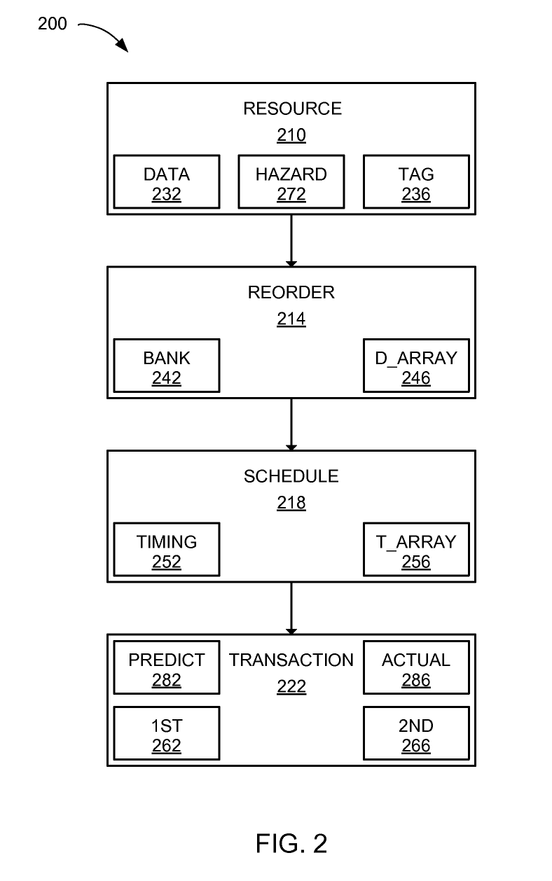

Referring now to FIG. 2, therein is shown a flow chart of a scheduler process 200 of the electronic system 100 in an embodiment of the invention. The scheduler process 200 can combine tag and data resource availability for optimal scheduling of concurrent transactions. The optimal scheduling of concurrent transactions can include dynamically reordering data access to avoid data array conflicts, scheduling data access to align with tag availability such as at a fixed cadence, or combination thereof.

It has been discovered that the electronic system 100 with the scheduler process 200 dynamically orders or reorders with intelligent scheduling to maintain maximum bandwidth. The intelligent scheduling maximizes utilization of shared tag and data resources such as the tag resources 236, the data resources 232, or combination thereof.

It has further been discovered that the electronic system 100 with the scheduler process 200 provides area-efficiency. The area-efficiency is due at least to eliminating the need for increasing a number of read/write ports on a cache.

In an embodiment of the electronic system 100, the scheduler process 200, such as a Level 2 (L2) scheduler process 200, can be implemented in hardware. The scheduler process 200 can be implemented with the control unit 112, the storage unit 114, or combination thereof. For illustrative purposes, the scheduler process 200 is shown having four process blocks although it is understood that the scheduler process 200 may have any number or any partitioning of process blocks.

The scheduler process 200 can include a resource process 210, a reorder data access process 214, a schedule data access process 218, an access transaction process 222, or combination thereof. The resource process 210 can determine a combination of availability for data resources 232, tag resources 236, or combination thereof. Based on the combination of availability for data resources 232, tag resources 236, or combination thereof, the reorder data access process 214 can dynamically reorder access to a data bank 242 of a data array 246, which can be stored on the storage unit 114 of FIG. 1.

The schedule data access process 218 can align access to the data bank 242 with the availability of tag resources 236, data resources 232, or combination thereof. This availability can provide a timing 252 such as a cadence based on a tag array 256, the data array 246, or combination thereof. The transaction process 222 can provide access to one of the data bank 242 such as a first transaction 262 and access to another of the data bank 242 such as a second transaction 266 without conflict with any of the data bank 242 of the data array 246, the tag array 256, or combination thereof.

The scheduler process 200 can combine tag resources 236 and data resources 232 availability for maximum bandwidth. The scheduler process 200 can also manage hazards 272 for the tag resource 236, the data resource 232, or combination thereof, dynamically without the need for stalling mechanisms, replay mechanisms, or combination thereof. The scheduler process 200 can also provide maximum bandwidth without the need for additional multiple read/write ports on a memory such as a cache.

The scheduler process 200 can be implemented more area efficiently than alternatives such as adding multiple read/write ports on the memory or cache. Further, the scheduler process 200 provides higher performance without resource constraints such as serialized accesses.

An embodiment of the electronic system 100 is applicable to a pipelined L2 cache design that includes a separate tag array (holding the physical tags of the cache lines and miscellaneous state) such as the tag array 256, which can be stored on the storage unit 114, as well as a data array 246. For an L2 transaction such as the first transaction 262, the second transaction, or combination thereof, these tag resources 236 and data resources 232 can get accessed and updated at various stages of the L2 pipeline. Such a pipelined design potentially supports higher L2 bandwidth than a serialized design, but may incur collisions among the overlapping transactions. These collisions may occur while trying to access the tag resources 236, the data resources 232, or combination thereof, in the same cycle.

An embodiment of the electronic system 100 proposes an L2 controller designed to intelligently schedule neighboring transactions such as the first transaction 262 and the second transaction 266, in ways to avoid resource conflicts such as the hazard 272. In some cases, the conflicts or the hazard 272 are avoided by reordering the access pattern of data banks 242 including data beats, words, or combination thereof, returned from the data array 246 such as an L2 data array.

Accesses for the data banks 242 can be dynamically ordered or reordered with intelligent scheduling to maintain maximum bandwidth. This intelligent scheduling maximizes utilization of shared tag and data resources such as the tag resources 236, the data resources 232, or combination thereof, and provides higher performance than stalling transactions, serializing transactions, or combination thereof. The intelligent scheduling can also provide area-efficiency at least by eliminating the need for increasing a number of read/write ports on a cache.

Ordering or reordering the data banks 242 including the data beats, the words, or combination thereof, can start from the critical word followed by remaining quad-words in sequential order. Newer lookups that occur while data banks are busy can be reordered based on matching a starting quad-word of an earlier transaction. This reordering can eliminate delays and sustain peak bandwidth.

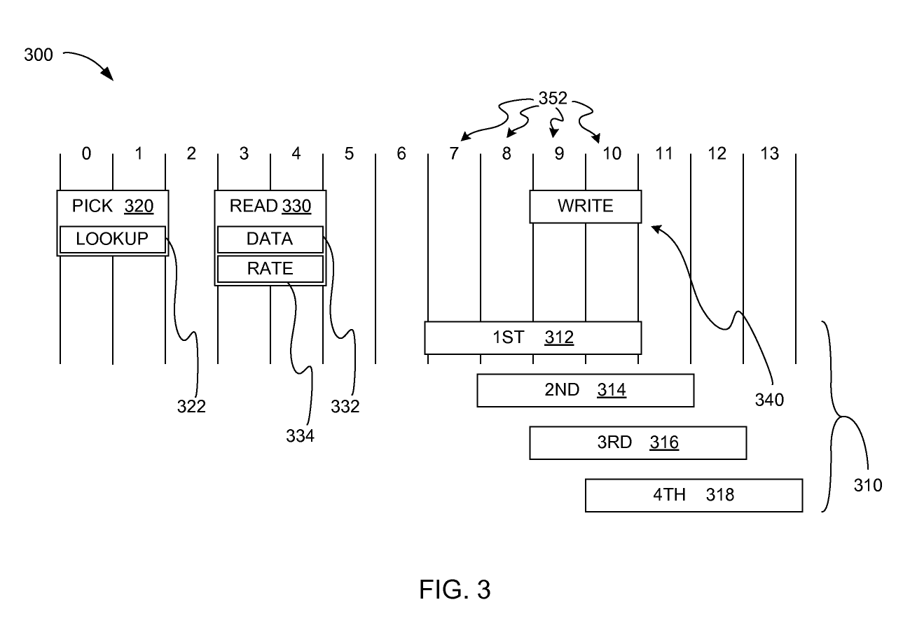

Referring now to FIG. 3, therein is shown a diagram of an example of a pipeline process 300 of the electronic system 100 in an embodiment of the invention. For illustrative purposes one cache configuration of the electronic system 100 is shown although it is understood that the electronic system 100 can include other cache configurations.

It has been discovered that the electronic system 100 with the scheduler process 200 of FIG. 2 avoids or eliminates delays. Avoiding or eliminating delays results in sustaining peak bandwidth.

It has further been discovered that the electronic system 100 with the scheduler process 200 can avoid data conflicts or collisions with reordering a transaction. The reordering of transactions includes starting with a different of the quad-words instead of the critical word.

For example, the pipeline process 300 such as an L2 access pipeline, can include a cache that can be stored on the storage unit 114 of FIG. 1, and includes a memory structure 310, such as a four bank structure, with a cache line interleaved across individual banks of the memory structure 310, such as a first bank including a first quad-word 312, a second bank including a second quad-word 314, a third bank including a third quad-word 316, a fourth bank including a fourth quad-word 318, or combination thereof. The first quad-word 312 can include a first data array, a Quad-Word 0, or combination thereof. The quad-word bank 314 can include a second data array, a Quad-Word 1, or combination thereof. The quad-word bank 316 can include a third data array, a Quad-Word 2, or combination thereof. The quad-word bank 318 can include a fourth data array, a Quad-Word 3, or combination thereof.

Further for example, a sixty four byte (64-byte) cache line can include each of the first bank, the second bank, the third bank, and the fourth bank, having a Quad-Word such as sixteen bytes (16 bytes). A cache line read can include accessing individual banks of the memory structure 310 in consecutive cycles and data return of each of the 16 bytes of the individual banks such as the first quad-word 312, the second quad-word 314, the third quad-word 316, the fourth quad-word 318, or combination thereof, to a requesting core such as the control unit 112 of FIG. 1.

Lookups for the cache configuration 300 can be arbitrated by a scheduler, such as the scheduler process 200 that can include a pick process 320 to pick the cache line read one by one by accessing a tag including the tag resource 236 of FIG. 2 such as an L2 tag, which can be stored on the storage unit 114 of FIG. 1. A read process 330 can match the tag resource 236 to a requested transaction address such as the memory structure 310 including the first quad-word 312, the second quad-word 314, the third quad-word 316, the fourth quad-word 318, or combination thereof.

The read process 330 can access the memory structure 310 starting with the quad-word, such as the first quad-word 312, the second quad-word 314, the third quad-word 316, the fourth quad-word 318, or combination thereof, that was requested by a requesting core such as the control unit 112. For example, access by the read process 330 can start with a requested quad-word such as a critical word and sequentially access remaining of the quad words including wrap around. For example, the critical word can be one of the first quad-word 312, the second quad-word 314, the third quad-word 316, or the fourth quad-word 318.

A write process 340 can process an update to an accessed or a hit in the cache of the L2 tags such as the tag resource 236 of the tag array 256 of FIG. 2, in parallel with a data read of the read process 330. Multiple accesses with the write process 340, the read process 330, or combination thereof can result in collisions with the data array of FIG. 2, the tag array 256, or combination thereof, within at least one of clock cycles 352. The collisions, such as the hazards 272 of FIG. 2, can occur during any of four of the clock cycles 352 for the read process 330 access of any of the first quad-word 312, the second quad-word 314, the third quad-word 316, or the fourth quad-word 318.

For example, one collision can result when the pick process 320 includes two different lookup transactions 322 such as different L2 lookup transactions picked back-to-back. If the different of the lookup transactions 322 request two different critical words or quad-words such as the first quad-word 312, the second quad-word 314, the third quad-word 316, the fourth quad-word 318, or combination thereof, the read process 330 can access a same of the critical words at substantially the same time in at least one of four of the clock cycles 352. Further for example, the pick process 320 can be scheduled, such as every four of the clock cycles 352, to match data rates 334 of the read process 330. For illustrative purposes, the read process 330 includes the data rates 334 shown as four of the clock cycles 352 although it is understood that any data rate or number of clock cycles can be used.

An embodiment of the electronic system 100 avoids this data conflict or collision with reordering one of the lookup transactions 322 to start with a different of the quad-words instead of the critical word. For example, given the critical word is the third quad-word 316 for two substantially concurrent of the lookup transactions 322, the scheduler process 200 can provide a second of the read process 330 with a start point of the first quad-word 312. Thus the reordering of the scheduler process 200 can allow concurrent access to multiple of the banks including the quad-words having each of the banks with the quad-words accessed by at most one of the lookup transactions 322 at any time.

The scheduler process 200 can reorder any number of the lookup transactions 322, such as additional or new of the lookup transactions 322, based on having the banks including the quad-words busy or currently accessed. Reordering of the words or quad-words such as the first quad-word 312, the second quad-word 314, the third quad-word 316, the fourth quad-word 318, or combination thereof, avoids or eliminates delays in reading or returning data, such as L2 data, with the read process 330. Thus avoids or eliminates delays results in sustaining peak bandwidth such as L2 data bandwidth.

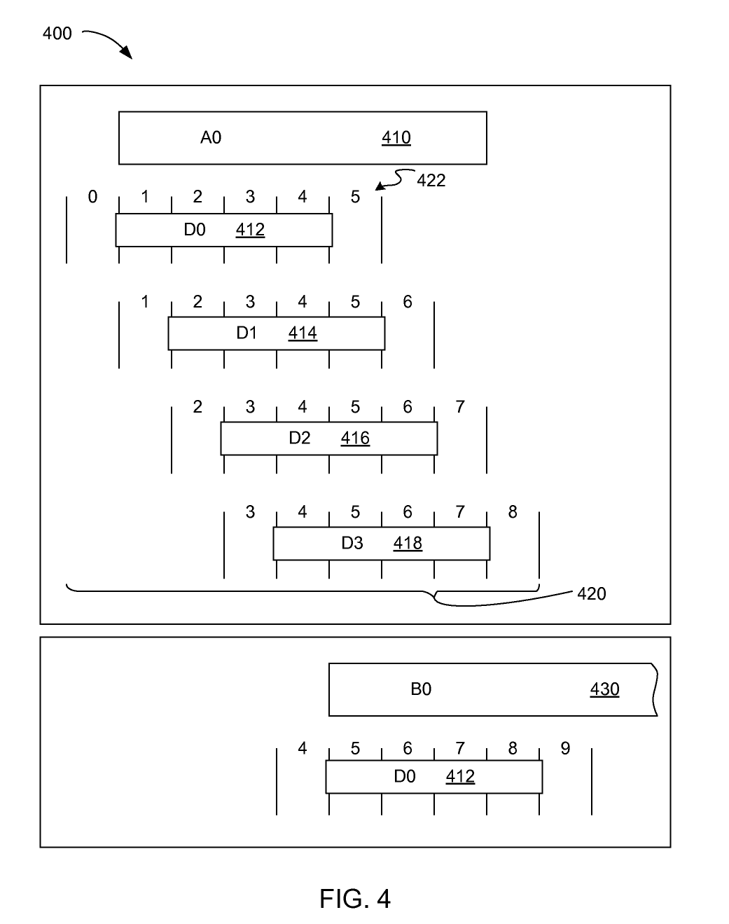

Referring now to FIG. 4, therein is shown a diagram of an example of a pipeline process 400 of the electronic system 100 in an embodiment of the invention. For illustrative purposes one cache configuration of the electronic system 100 is shown although it is understood that the electronic system 100 can include other cache configurations.

It has been discovered that the electronic system 100 with the scheduler process 200 of FIG. 2 can avoid delays due to conflicts, such as collisions or the hazards 272 of FIG. 2. The conflicts can result from more than one of a data read access.

It has further been discovered that the electronic system 100 with the scheduler process 200 can reorder a second data read access to a critical quad-word of a first data read access. The reordering avoids stalling the second data read access.

In an embodiment of the electronic system 100, the pipeline process 400 such as an L2 data array, which can be stored on the storage unit 114 of FIG. 2, includes a four bank structure with a cache line interleaved across for individual banks For example, a sixty four byte (64-byte) cache line can include each of the four banks having a Quad-Word such as sixteen bytes (16 bytes). A cache line read can include accessing the individual banks in consecutive cycles.

An embodiment of the electronic system 100 can include latency in accessing each of the banks including the first quad-word 312, the second quad-word 314, the third quad-word 316, the fourth quad-word 318, or combination thereof. As an example, each quad-word or L2 quad-word can provide sixteen bytes, such as a quad-word, for a cache line of sixty-four bytes (64-bytes) with four accesses launched in four successive or sequential of cycles such as clock cycles 420 including a conflict cycle 422 such as a clock cycle 5.

In an exemplary embodiment of the pipeline process 400, an A0 read access 410, such as the read process 330 of FIG. 3 for address A0, can start with D0 412, such as data array 0 or Quad Word 0, as a critical quad-word requested by a core such as the control unit 112 of FIG. 1. The A0 read access 410 can include successive or sequential access of the D0 412, D1 414 such data array 1 or Quad Word 1, D2 416 such as data array 2 or Quad Word 2, and D3 418 such as data array 3 or Quad Word 3.

Further to the exemplary embodiment of the pipeline process 400, a B0 read access 430, such as another of the read process 330 for B0, can start with the D1 414 as a critical quad-word. The B0 read access 430, with a four cycle schedule after the A0 read process 410 to match a latency of data arrays, can conflict with the read process for address A0 accessing D1 414 in the conflict cycle 422. Thus the B0 read access 430 can stall until the A0 read process 410 completes.

In an exemplary embodiment of the electronic system 100, a scheduler process such as the scheduler process 200, can order or reorder the B0 read access 430 to start with the D0 412 such as the critical quad-word of the A0 read access 410. A scheduler process such as the scheduler process 200 of FIG. 2 of the electronic system 100 can avoid stalling the B0 read access 430 for better utilization of the pipeline process 400 such L2 memory banks

Further to the exemplary embodiment of the electronic system 100, the data including the D0 412, the D1 414, the D2 416, and the D3 418 can be provided to the core in an order, which can delay a critical Quad-Word such as the D1 414. The delay of the D1 414 could not be avoided due to the conflict with the A0 read access 410 but delays for the data including the D0 412, the D2 416, and the D3 418, can be avoided providing maximum bandwidth for the B0 read access 430.

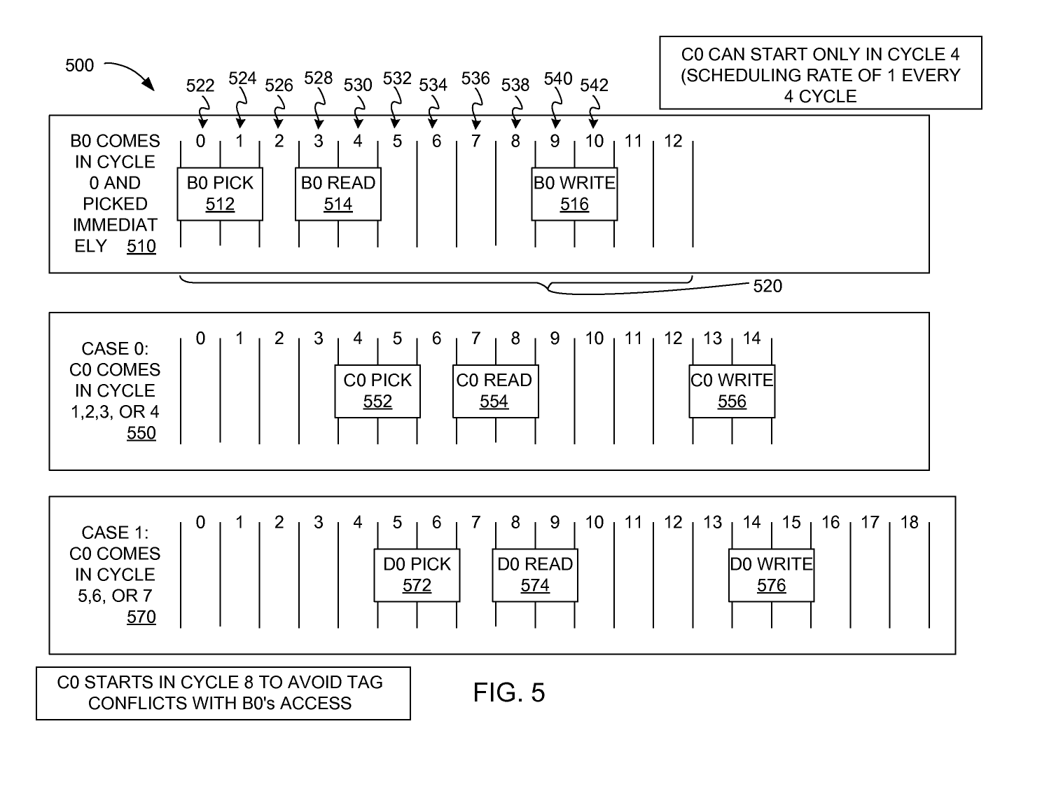

Referring now to FIG. 5, therein is shown a diagram of an example of a cache configuration 500 of the electronic system 100 in an embodiment of the invention. For illustrative purposes one cache configuration of the electronic system 100 is shown although it is understood that the electronic system 100 can include other cache configurations.

It has been discovered that the electronic system 100 with the scheduler process 200 of FIG. 2 avoids conflicts or collisions by only picking another transaction such as a new L2 access that never conflicts with an older in flight or in progress transaction. The conflicts or collisions include conflicts or collisions with tag arrays.

It has further been discovered that the electronic system 100 with the scheduler process 200 can start another transaction such as a new L2 access in a cadence, such as a number of clock cycles apart from a read and a write, to avoid conflicts or collisions. The constraints of this cadence have a negligible impact on performance.

In an embodiment of the electronic system 100, the cache configuration 500 such as an L2 data array, which can be stored on the storage unit 114 of FIG. 2, resolves conflicts with tag arrays such as the tag array 256 of FIG. 2, which can be stored on the storage unit 114 of FIG. 1. A B0 transaction 510, such as an older or in progress transaction, can include a B0 pick process 512 such as a tag pick process, a B0 read process 514 such as a tag read process, a B0 write process 516 such as a tag write process, or combination thereof. The B0 transaction 510 can access the cache configuration 500 in cycles 520 such as clock cycles.

For example the B0 pick process 512 can start in cycle zero 522 such as clock cycle zero and complete in cycle one 524 such as clock cycle one. The B0 read process 514 can start one of the cycles 520 apart from the B0 pick process 512. Thus, after cycle two 526 such as clock cycle two, the B0 read process 514 can start in cycle three 528 such as clock cycle three and complete in cycle four 530 such as clock cycle four. The B0 write process 516 can start four of the cycles 520 apart from the B0 read process 514. Thus, after cycle five 532 such as clock cycle five, cycle six 534 such as clock cycle six, cycle seven 536 such as clock cycle seven, and cycle eight 538 such as clock cycle eight, the B0 write process 516, can start in cycle nine 540 such as clock cycle nine and complete in cycle ten such as clock cycle 10.

In an example, a C0 transaction 550, such as a younger transaction or a second transaction, can include a C0 pick process 552, a C0 read process 554, a C0 write process 556, or combination thereof. A tag read, such as the B0 read process 514 or the C0 read process 554, and a tag write, such as the B0 write process 516 or the C0 write process 518, are two cycles each and four cycles apart from each other. The scheduling of accesses or transactions, such as the B0 transaction 510 or the C0 transaction 550, is one every four cycles. The B0 transaction 510 starts in the cycle zero 522 requiring a subsequent access, such as the C0 transaction 550, to start in the cycle four 530 based on a request in the cycle one 524, the cycle two 526, the cycle three 528, or the cycle 4 530.

In another example, a request arrives after the cycle four 530 and in a cycle of the cycles 520 that is not aligned to a four cycle schedule. A D0 transaction 570, such as a younger transaction, a second transaction, or another of the C0 transaction 550, can include a D0 pick process 572, a D0 read process 574, or combination thereof. The D0 read process 574 can conflict with the B0 write process 516 due to the D0 transaction 570 starting in the cycle five 532, the cycle six 534, or the cycle seven 536. The B0 write process 516 can update a tag such as the tag resource 236 of FIG. 2 and the D0 read process 574 can request access of the same tag.

In an embodiment of the electronic system 100, the scheduler process 200 starts the D0 pick process 572 with the timing 252 of FIG. 2 including a cadence of four cycles such as the cycle eight 538. The cadence of four cycles matches the number of the cycles 520 apart from or between the C0 read process 514 and the C0 write process 516. The cadence of the scheduler process 200 avoids conflicts with the tag array 256 of FIG. 2 based on conflicts or collisions such as the hazard 272 of FIG. 2. Starting pick processes, such as the D0 pick process 572, based on the tag bandwidth, the data bandwidths, the timing 252 of FIG. 2, or combination thereof, simplifies design. The simplified design avoids adding read/write tag ports on a memory or cache, interlock processes for dynamically stalling transactions, or combination thereof. Constraints of starting the D0 pick process 572 at the cadence have a negligible impact on performance.

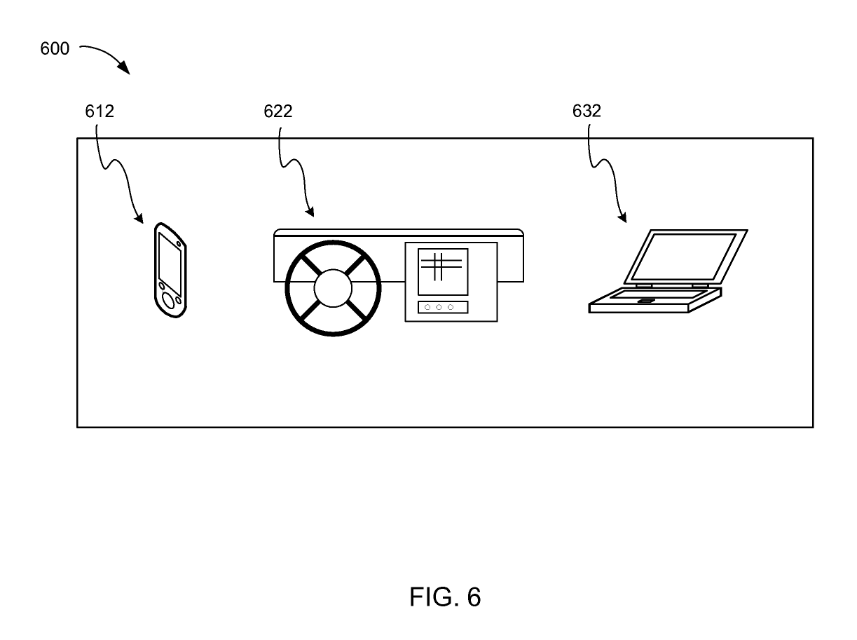

Referring now to FIG. 6, therein is shown exemplary embodiments of the electronic system 100. The exemplary embodiments include application examples for the electronic system 100 such as a smart phone 612, a dash board of an automobile 622, a notebook computer 632, or combination thereof.

These application examples illustrate purposes or functions of various embodiments of the invention and importance of improvements in processing performance including improved bandwidth, area-efficiency, or combination thereof. For example, the scheduler process 200 of FIG. 2 can maximize utilization and bandwidth of shared tag and data resources such as the tag resources 236, the data resources 232, or combination thereof.

In an example where an embodiment of the invention is an integrated circuit processor and the scheduler process 200 is integrated in the control unit 112 of FIG. 2, the storage unit 114, or combination thereof, concurrent transactions can be significantly faster than other devices without the scheduler process 200. Various embodiments of the invention provide optimal scheduling of concurrent transactions without the need for increasing a number of read/write ports on a cache.

The electronic system 100, such as the smart phone 612, the dash board of the automobile 622, and the notebook computer 632, can include a one or more of a subsystem (not shown), such as a printed circuit board having various embodiments of the invention, or an electronic assembly (not shown) having various embodiments of the invention. The electronic system 100 can also be implemented as an adapter card in the smart phone 612, the dash board of the automobile 622, and the notebook computer 632.

Thus, the smart phone 612, the dash board of the automobile 622, the notebook computer 632, other electronic devices, or combination thereof, can provide significantly faster throughput with the electronic system 100 such as processing, output, transmission, storage, communication, display, other electronic functions, or combination thereof. For illustrative purposes, the smart phone 612, the dash board of the automobile 622, the notebook computer 632, other electronic devices, or combination thereof, are shown although it is understood that the electronic system 100 can be used in any electronic device.

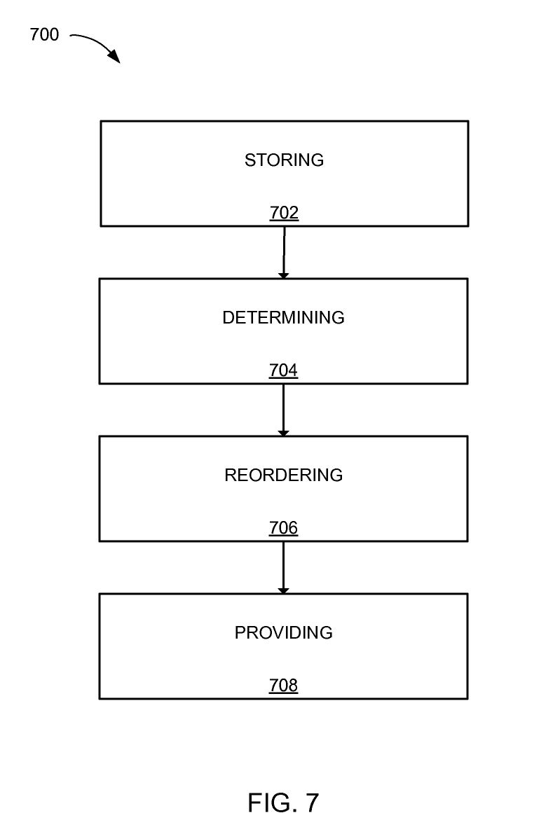

Referring now to FIG. 7, therein is shown a flow chart of a method 700 of operation of an electronic system 100 in an embodiment of the present invention. The method 700 includes: storing, with a storage unit, a data array in a block 702; determining, with a control unit, availability of the data array in a block 704; reordering, with the control unit, access to the data array in a block 706; and providing, with the control unit, access to the data array in a block 708.

All of the processes herein can be implemented as hardware, hardware circuitry, or hardware accelerators with the control unit 112 of FIG. 1. The processes can also be implemented as hardware, hardware circuitry, or hardware accelerators with the device 102 of FIG. 1 and outside of the control unit 112.

The electronic system 100 has been described with process functions or order as an example. The electronic system 100 can partition the processes differently or order the processes differently. For example, the access transaction process 222 of FIG. 2 can provide access to one of the data bank 242 such as a first transaction 262 and access to another of the data bank 242 such as a second transaction 266 based on the resource process 210 of FIG. 2. Alternatively, the access transaction process 222 can provide access to one of the data bank 242 based on the schedule data access process 218 before the resource process 210, the reorder data access process 214 of FIG. 2, or combination thereof.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a storage unit configured to store a data array;
a control unit, coupled to the storage unit, configured to:
determine availability of the data array;
reorder access to the data array; and
provide access to the data array.

2. The system as claimed in claim 1 wherein the control unit is configured to determine availability of a tag array.

3. The system as claimed in claim 1 wherein the control unit is configured to provide timing based on availability of data resources.

4. The system as claimed in claim 1 wherein the control unit is configured to provide timing based on availability of tag resources.

5. The system as claimed in claim 1 wherein the control unit is configured to reorder access to a data bank, which is not a critical word, of the data array.

6. The system as claimed in claim 1 wherein the control unit is configured to schedule access to a tag array.

7. The system as claimed in claim 1 wherein the control unit is configured to schedule access based on timing.

8. The system as claimed in claim 1 wherein the storage unit is configured to store a tag array.

9. The system as claimed in claim 1 wherein the storage unit is configured to store a data bank of the data array.

10. The system as claimed in claim 1 wherein the storage unit is configured to store a Level 2 cache data array.

11. A method of operation of an electronic system comprising:
storing, with a storage unit, a data array;
determining, with a control unit, availability of the data array reordering access to the data array; and
providing access to the data array.

12. The method as claimed in claim 11 wherein determining availability includes determining availability of a tag array.

13. The method as claimed in claim 11 further comprising providing timing based on availability of data resources.

14. The method as claimed in claim 11 further comprising providing timing based on availability of tag resources.

15. The method as claimed in claim 11 wherein reordering access includes reordering access to a data bank, which is not a critical word, of the data array.

16. The method as claimed in claim 11 further comprising scheduling access to a tag array.

17. The method as claimed in claim 11 further comprising scheduling access based on timing.

18. The method as claimed in claim 11 wherein storing includes storing a tag array.

19. The method as claimed in claim 11 wherein storing includes storing a data bank of the data array.

20. The method as claimed in claim 11 wherein storing includes storing a Level 2 cache.
